(19) United States
(12) Patent Application Publication
(10) Pub. No.: US 2015/0120142 A1
(43) Pub. Date: Apr. 30, 2015

(54) STEERING CONTROL APPARATUS HAVING FUNCTION OF DETERMINING INTENTION OF DRIVER AND METHOD OF OPERATING THE SAME

(71) Applicant: ELECTRONICS AND TELECOMMUNICATIONS RESEARCH INSTITUTE, Daejeon-city (KR)

(72) Inventors: Myung-Wook PARK, Daejeon (KR); Yong-Bon KOO, Daejeon (KR); Sang-Woo LEE, Daejeon (KR); Woo-Yong HAN, Daejeon (KR)

(73) Assignee: ELECTRONICS AND TELECOMMUNICATIONS RESEARCH INSTITUTE, Daejeon-city (KR)

(21) Appl. No.: 14/504,377

(22) Filed: Oct. 1, 2014

(30) Foreign Application Priority Data
Oct. 31, 2013 (KR) 10-2013-0131591

(51) Int. Cl. B62D 6/10; B60W 50/08

(52) U.S. Cl. CPC B62D 6/10; B60W 50/087
USPC 701/41

(57) ABSTRACT

The present invention relates to a steering control apparatus and a method of operating the apparatus. The steering control apparatus of the present invention includes a sensor unit for sensing movement of an autonomous driving vehicle or a limited autonomous driving vehicle, and calculating movement information. A determination unit determines a driver's steering intention using an actual steering torque value of the vehicle, calculated based on the movement information, and a reference value corresponding to speed of the vehicle, and decides on a driving control agent. A control unit transfers a driving control authority of the vehicle depending on the driving control agent.

### CROSS REFERENCE TO RELATED APPLICATION

This application claims the benefit of Korean Patent Application No. 10-2013-0131591, filed on Oct. 31, 2013, which is hereby incorporated by reference in its entirety into this application.

### BACKGROUND OF THE INVENTION

1. Technical Field

The present invention relates generally to a steering control apparatus and a method of controlling the steering control apparatus and, more particularly, to an apparatus that determines the steering intention of a driver for a steering wheel and controls steering during the autonomous driving or limited autonomous driving of a vehicle, and to a method of operating the apparatus.

2. Description of the Related Art

Intelligent vehicles for providing an automatic steering function to drivers, such as a Smart Parking Assist System (SPAS), a Lane Keeping Assist System (LKAS), and an Autonomous Driving System (ADS), have been developed. Such an intelligent vehicle assists, for example, lateral driving, and enables automatic manipulation of the vehicle, thus improving drivers' safety and convenience.

Here, a Smart Parking Assist System (SPAS) is a system for searching for an available parking area using space search sensors installed on the front/rear and left/right sides of a vehicle and controlling the vehicle's steering wheel, thus assisting a driver in parking. When such an SPAS automatically controls steering so as to assist the driver in parking, if the driver takes the steering wheel, the system senses such an operation, and transfers the driving control authority from the system to the driver. However, this operation may cause a problem in stability because a parking assist mode is released without determining whether the driver has intentionally taken the steering wheel with a steering intention or has moved it by mistake. Further, the function of the SPAS for transferring the driving control authority is available only in a speed section in which the SPAS is operated.

Meanwhile, a Lane keeping Assist System (LKAS) is a system in which, when a vehicle is moving at designated speed or more, a camera installed on the vehicle senses the lane of the vehicle and in which, if the vehicle departs from the lane without turning on an indicator, a steering system generates steering torque, and maintains the lane of the vehicle or returns the vehicle to a center of the lane. LKASs developed to date function only to generate steering torque and return the vehicle to a center of the lane in order to prevent the vehicle from departing from the lane. During this procedure, even if a driver intervenes in driving while the system is in operation, the system is maintained. That is, when the LKAS is operating, the steering system continues to be automatically controlled even if the driver has a steering intention or a situation in which the driver must control the vehicle by manually manipulating the steering system as in the case of emergency avoidance occurs, and thus the driving control authority is not transferred. Therefore, LKAS is problematic in that the driving stability of a vehicle is deteriorated and the driver is placed in a dangerous situation, as described above.

Unlike an unmanned autonomous driving vehicle, an Autonomous Driving System (ADS) is a system in which an agent such as a driver is present, and the lateral control and longitudinal control of a vehicle are simultaneously performed by a control system depending on the situation of the driver and driving conditions. Examples of such an autonomous driving system include Google's ‘self driving cars’, systems developed in Volvo's SARTRE (SAfe Road TRains for the Environment) project, etc. In such a system, if a driver does not have an intention to manipulate the steering wheel of a vehicle while the vehicle is being autonomously driven, an autonomous driving mode must not be released even if a force is applied to the steering wheel by mistake. Further, when the driver has a steering intention or an emergency occurs and then the driver intentionally manipulates the steering wheel, the driving control authority must be promptly taken from a controller.

In relation to this, there is Japanese Patent No. 2829933 entitled “Apparatus for controlling autonomous driving vehicle.”

### SUMMARY OF THE INVENTION

Accordingly, the present invention has been made keeping in mind the above problems occurring in the prior art, and an object of the present invention is to provide an apparatus that determines a driver's intention to manipulate a steering wheel and performs steering control corresponding to the driver's intention during the autonomous driving or the limited autonomous driving of a vehicle, and a method of operating the apparatus.

In accordance with an aspect of the present invention to accomplish the above object, there is provided a steering control apparatus, including a sensor unit for sensing movement of an autonomous driving vehicle or a limited autonomous driving vehicle, and calculating movement information; a determination unit for determining a driver's steering intention using an actual steering torque value of the vehicle, calculated based on the movement information, and a reference value corresponding to speed of the vehicle, and deciding on a driving control agent; and a control unit for transferring a driving control authority of the vehicle depending on the driving control agent.

The determination unit may include a steering torque prediction module for calculating a predictive steering torque value using speed, steering angle and steering angular velocity information of the vehicle included in the movement information; and a steering intention determination module for comparing a difference between the actual steering torque value and the predictive steering torque value with the reference value corresponding to the speed of the vehicle, thus determining the driver's steering intention.

The steering intention determination module may be configured to, if the difference between the actual steering torque value and the predictive steering torque value is greater than the reference value, determine that the driver has a steering intention.

The determination unit may be configured to, if it is determined that the driver has a steering intention, compare a number of variations in a torque value of a steering wheel occurring for a preset period of time with a preset reference number of variations.

The determination unit may be configured to, if the number of variations is less than the preset reference number of variations, determine that the driving control agent is the driver.

The control unit may be configured to, if it is determined by the determination unit that the driver has a steering intention, perform Electric Power Steering (EPS) control via a transferring module.

The sensor unit may include at least one of a steering torque sensor, a steering angle sensor, a steering angular velocity sensor, a vehicle speed sensor, a yaw rate sensor, and an acceleration sensor.

In accordance with another aspect of the present invention to accomplish the above object, there is provided a method of operating a steering control apparatus, including sensing, by a sensor unit, movement of an autonomous driving vehicle or a limited autonomous driving vehicle; calculating, by the sensor unit, movement information based on the movement; determining, by a determination unit, a driver's steering intention using an actual steering torque value of the vehicle, calculated based on the movement information, and a reference value corresponding to speed of the vehicle, and deciding on, by the determination unit, a driving control agent based on the driver's steering intention; and transferring, by a control unit, a driving control authority of the vehicle depending on the driving control agent.

Deciding on the driving control agent may include calculating, by a steering torque prediction module, a predictive steering torque value using speed, steering angle and steering angular velocity information of the vehicle included in the movement information; and comparing, by a steering intention determination module, a difference between the actual steering torque value and the predictive steering torque value with the reference value corresponding to the speed of the vehicle, thus determining the driver's steering intention.

Deciding on the driving control agent may include determining, by the steering intention determination module, that the driver has a steering intention if the difference between the actual steering torque value and the predictive steering torque value is greater than the reference value.

Deciding on the driving control agent may include, if it is determined that the driver has a steering intention, comparing a number of variations in a torque value of a steering wheel occurring for a preset period of time with a preset reference number of variations.

Comparing the number of variations with the preset reference number of variations may include, if the number of variations is less than the preset reference number of variations, determining that the driving control agent is the driver.

Transferring the driving control authority of the vehicle may include, if it is determined by the determination unit that the driver has a steering intention, performing Electric Power Steering (EPS) control via a transferring module.

The sensor unit may include at least one of a steering torque sensor, a steering angle sensor, a steering angular velocity sensor, a vehicle speed sensor, a yaw rate sensor, and an acceleration sensor.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing a steering control apparatus according to an embodiment of the present invention;

FIG. 2 is a block diagram showing a determination unit included in the steering control apparatus according to an embodiment of the present invention;

FIG. 3 is a graph showing a variation in torque depending on a driver's steering intention and a variation in torque in other cases according to an embodiment of the present invention;

FIG. 4 is a block diagram showing a control unit included in the steering control apparatus according to an embodiment of the present inventions;

FIG. 5 is a flowchart showing a method of operating the steering control apparatus according to an embodiment of the present invention; and

FIG. 6 is a flowchart showing the step of deciding on a driving control agent based on movement information, the step being included in the method of operating the steering control apparatus according to an embodiment of the present invention.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clearer.

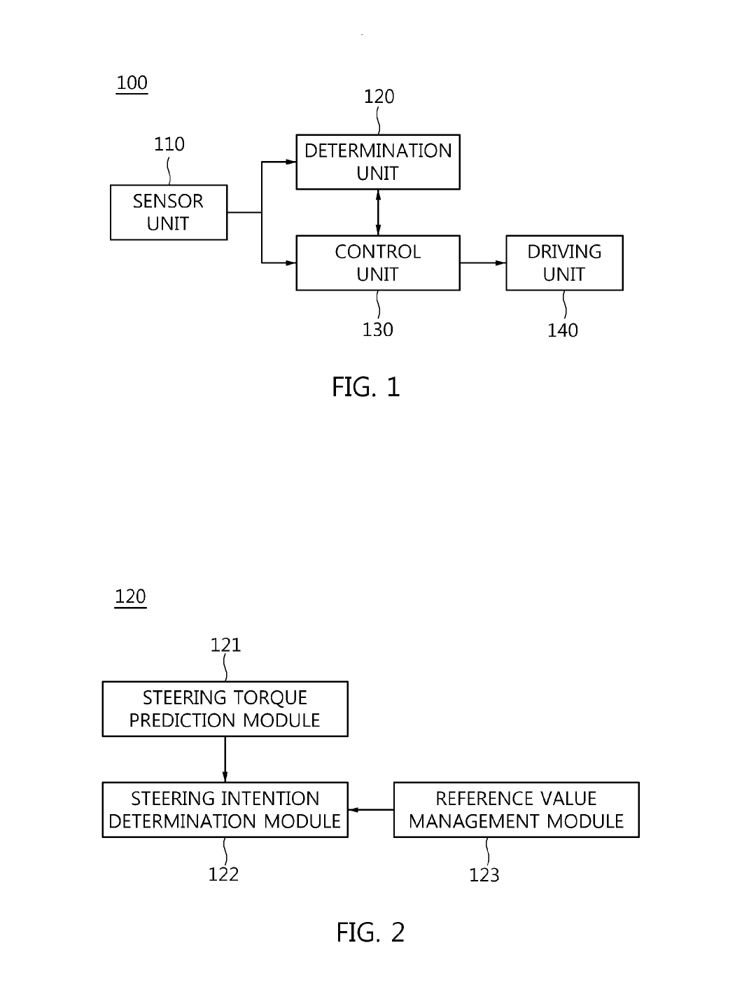

Hereinafter, a steering control apparatus 100 according to an embodiment of the present invention will be described in detail with reference to FIG. 1. FIG. 1 is a block diagram showing a steering control apparatus according to an embodiment of the present invention. The steering control apparatus 100 according to an embodiment of the present invention may include a sensor unit 110, a determination unit 120, a control unit 130, and a driving unit 140. Individual components included in the steering control apparatus 100 will be described below.

The sensor unit 110 functions to sense the movement of a vehicle and calculate movement information. Here, the vehicle may include an autonomous driving vehicle or a limited autonomous driving vehicle. The sensor unit 110 may include at least one of a steering torque sensor, a steering angle sensor, a steering angular velocity sensor, a vehicle speed sensor, a yaw rate sensor, and an acceleration sensor. That is, the movement information calculated by the sensor unit 110 may include various types of information such as the current movement information of the vehicle, for example, the steering torque, steering angle, steering angular velocity, current speed, yaw rate, and acceleration of the vehicle. Further, the movement information denotes information used to perform functions in the determination unit 120 and the control unit 130, which will be described later.

The determination unit 120 functions to calculate the actual steering torque value and the predictive steering torque value of the vehicle, based on the movement information calculated by the sensor unit 110. In this case, the actual steering torque value denotes a steering torque value applied from a vehicle that is currently traveling. That is, the actual steering torque value denotes a torque value output from the torque sensor actually mounted on a steering column.

Further, the predictive steering torque value is a steering torque value predicted using the speed, steering angle, and steering angular velocity information of the vehicle. That is, the predictive steering torque value is a steering torque value matching the current speed, steering angle, and steering angular velocity of the vehicle when an external force (for example, the user's steering manipulation) is not applied. The predictive steering torque value may be stored as different values in a separate mapping table depending on the speed, steering angle, and steering angular velocity. Further, the predictive steering torque value may be calculated using a separate algorithm calculation procedure. Here, the reason for needing the speed of the vehicle to calculate the predictive steering torque value is that as the vehicle is driven from low speed to high speed, reaction transferred through the steering wheel is decreased, and thus a force acting on the torque sensor may be weakened.

Thereafter, the determination unit 120 functions to determine the driver's steering intention based on a comparison between the calculated actual steering torque value and predictive steering torque value, and decide on a driving control agent. In detail, the determination unit 120 may determine the driver's steering intention by comparing a difference between the actual steering torque value and the predictive steering torque value with a preset reference value. Here, the reference value denotes a value used to determine whether a steering torque value applied to the vehicle is obtained via the driver's steering intention. Further, the reference value may be stored in a separate management unit and may be set to different values depending on the current speed of the vehicle.

If the difference between the actual steering torque value and the predictive steering torque value exceeds a preset reference value, the determination unit 120 may determine that the driver has a steering intention. Otherwise, the determination unit 120 may determine that the driver desires to maintain a current state and does not have an intention to manually drive. Based on the results of the determination by the determination unit 120, a driving control agent may be decided on. As described above, the current vehicle is assumed to be in an autonomous driving state or a limited autonomous driving state. That is, based on the results of the determination unit 120, the driving control agent may be maintained in the autonomous driving state or the limited autonomous driving state, or may be transferred from the autonomous driving system to the driver.

Further, if the number of variations in a torque value occurring for a preset period of time is less than the preset reference number of variations, the determination unit 120 may determine that the driving control agent is the driver. That is, during the travel of the vehicle, the steering wheel may be moved by an external force or by the driver's mistake. Such a determination procedure is performed in preparation for the case of such malfunction. That is, if the number of variations in the torque value occurring for the preset period of time is greater than the preset reference number of variations, the driving control authority is not transferred to the driver.

The control unit 130 functions to transfer the driving control authority of the vehicle depending on the determined driving control agent. That is, if it is determined by the determination unit 120 that the driving control agent is the driver, the driving control agent is transferred from the system to the driver, and a steering control method may be performed using Electric Power Steering (EPS) control for assisting the driver in steering. Of course, it should be understood that the method of assisting the driver in steering is not limited to EPS control and may be implemented using various methods. Further, if it is determined by the determination unit 120 that the driving control agent is not the driver, the control unit 130 may perform control such that the current state is maintained. For such a control operation, the control unit 130 may perform control using the movement information calculated by the sensor unit 110.

The driving unit 140 functions to generate a driving torque under the control of the control unit 130 and control the vehicle.

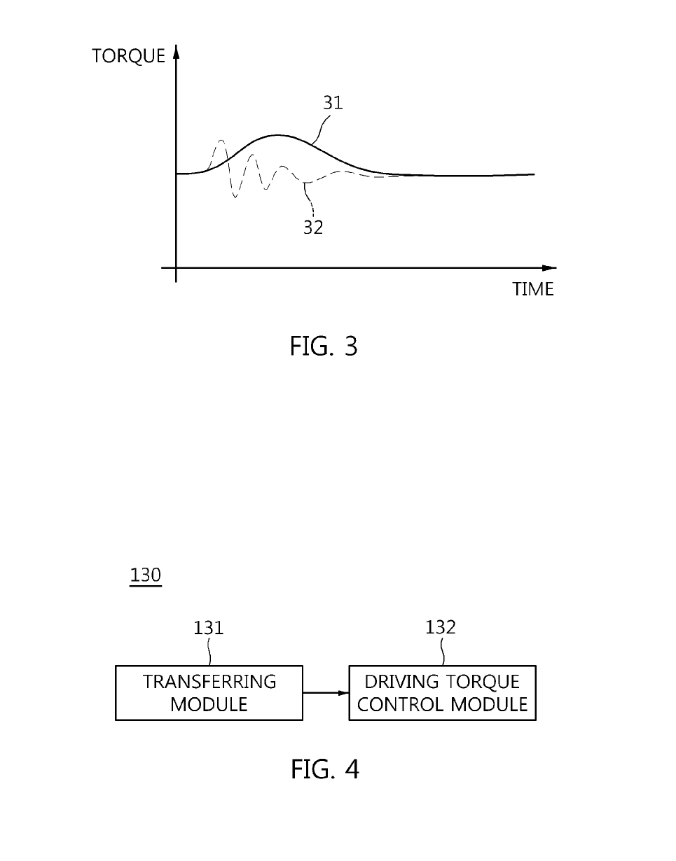

Below, the determination unit included in the steering control apparatus of the present invention will be described in detail with reference to FIGS. 2 and 3. FIG. 2 is a block diagram showing the determination unit included in the steering control apparatus according to an embodiment of the present invention. FIG. 3 is a graph showing a variation in torque depending on a driver's steering intention and a variation in torque in other cases according to an embodiment of the present invention. As shown in FIG. 2, the determination unit may include a steering torque prediction module 121, a steering intention determination module 122, and a reference value management module 123. A detailed description of the modules will be made below.

As described above with reference to FIG. 1, the steering torque prediction module 121 functions to calculate a predictive steering torque value using the speed, steering angle, and steering angular velocity information of the vehicle included in the movement information calculated by the sensor unit. As described above, the predictive steering torque value denotes a steering torque value matching the current speed, steering angle and steering angular velocity of the vehicle when an external force is not applied, for example, when there is no steering manipulation of the user or when a variation in steering caused by vibration during the travel of the vehicle is not present. That is, the steering torque value may be used as a reference value when determining whether the driver has a steering intention, as described above.

The steering intention determination module 122 functions to compare a difference between the actual steering torque value and the predictive steering torque value calculated by the steering torque prediction module 121 with the reference value corresponding to the speed of the vehicle. Here, as described above, the reference value is a value to be compared with the difference between the actual steering torque value occurring in the vehicle and the predictive steering torque value of the steering torque prediction module 121, and is used as a basis for determining whether steering manipulation is currently being performed by the driver.

Via the comparison procedure, the steering intention determination module 122 may determine the driver's steering intention via the comparison between those values. In detail, if the difference between the actual steering torque value and the predictive steering torque value is greater than the reference value, the steering intention determination module 122 may determine that the driver has a steering intention. Otherwise, the steering intention determination module 122 may determine that the current autonomous driving or limited autonomous driving state must be maintained. By using determination based on the comparison procedure, the driver's intention to control driving may be determined.

Further, in the above procedure, if it is determined that the driver has a steering intention, the steering intention determination module 122 may further compare the number of variations in the torque value of the steering wheel occurring for a preset period of time with the preset reference number of variations. That is, if it is determined by the steering intention determination module 122 that the number of variations is less than the reference number of variations, it may be determined that the driving control agent is the driver. Otherwise, the steering intention determination module 122 re-performs the above-described procedure of comparing the difference between the actual steering torque value and the predictive steering torque value with the reference value corresponding to the speed of the vehicle. Via this procedure, the steering control apparatus 100 of the present invention may prevent malfunction that may occur due to the driver's mistake, the uneven state of a ground surface, or the like. Such a procedure may be further clarified by referring to FIG. 3.

In FIG. 3, a solid line 31 indicating a variation in a torque value based on the actual steering manipulation of a driver and a dotted line 32 indicating a variation that may occur due to the driver's mistake or the state of a road are illustrated. It is assumed that a rise in the torque value is the application of force to the left side of a vehicle and a fall in the torque value is the application of force to the right side of the vehicle. That is, when the driver performs steering manipulation, the torque value uniformly rises and falls, as shown in FIG. 3. In other states, a variation may occur several times in the rate of variation in the torque value. That is, by means of these characteristics, the driver's steering intention may be further determined using the variation in the torque value.

The reference value management module 123 functions to manage the reference value used by the steering intention determination module 122. As described above, the reference value is set to the value corresponding to the travel speed of the vehicle depending on the travel speed. Since the description of the reference value has been made in detail with reference to FIG. 1, a repeated description thereof will be omitted for the simplification of the present specification.

Below, the control unit included in the steering control apparatus of the present invention will be further described with reference to FIG. 4. FIG. 4 is a block diagram showing the control unit included in the steering control apparatus according to an embodiment of the present invention. As shown in FIG. 4, the control unit may include a transferring module 131 and a driving torque control module 132. A description of the modules will be made below.

The transferring module 131 functions to transfer the driving control authority of the vehicle depending on the driving control agent determined by the determination unit 120. That is, if the determination unit 120 determines that the driving control agent is the driver, the transferring module 131 functions to transfer the driving control agent to the driver. Otherwise, the transferring module 131 may maintain a current state without performing a separate transferring procedure.

The driving torque control module 132 functions to control driving torque depending on the driving control agent transferred or maintained by the transferring module 131. That is, when the driving control agent is transferred to the driver, the control unit performs Electric Power Steering (EPS) control for assisting the driver in steering as a steering control method. The driving torque control module 132 transfers a control command for driving torque suitable for such assistant control to the driving unit, thus enabling the vehicle to be controlled. In contrast, even if the driving control agent is not transferred, the driving torque control module 132 transfers a control command for driving torque suitable for autonomous driving or limited autonomous driving of the vehicle to the driving unit. Here, the driving torque may be calculated based on the movement information calculated by the sensor unit.

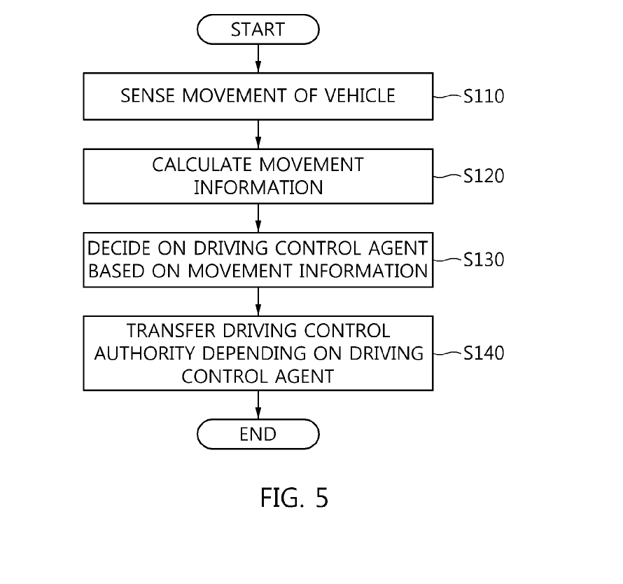

Hereinafter, a method of operating the steering control apparatus according to an embodiment of the present invention will be described in detail with reference to FIG. 5. FIG. 5 is a flowchart showing a method of operating the steering control apparatus according to an embodiment of the present invention. In the following description, it should be understood that a description of repeated components will be omitted for the simplification of description of the present specification.

First, at step S110, the movement of a vehicle is sensed by the sensor unit. Here, the vehicle is an autonomous driving vehicle or a limited autonomous driving vehicle, as described above with reference to FIG. 1.

At step S120, movement information is calculated by the sensor unit, based on the movement of the vehicle. Here, the movement information may include the current movement information of the vehicle, for example, various types of information such as the steering torque, steering angle, steering angular velocity, current speed, yaw rate, and acceleration of the vehicle. Here, it should be understood that the movement information is not limited to the above examples and may further include various types of information indicating the movement information of the vehicle. For this, as described above with reference to FIG. 1, the sensor unit that performs steps S110 and S120 may include at least one of a steering torque sensor, a steering angle sensor, a steering angular velocity sensor, a vehicle speed sensor, a yaw rate sensor, and an acceleration sensor.

Thereafter, at step S130, a driving control agent is decided on by the determination unit based on the movement information. In detail, at step S130, the driver's steering intention is determined using the actual steering torque value of the vehicle calculated based on the movement information and a reference value corresponding to the speed of the vehicle, and the driving control agent is decided on based on the driver's steering intention.

Further, at step S130, a predictive steering torque value may also be calculated in addition to the actual steering torque value. As described above, the actual steering torque value is a steering torque value actually applied to the vehicle that is currently traveling, and denotes a value output from the torque sensor mounted on a steering column. Further, the predictive steering torque value is a steering torque value predicted using the speed, steering angle, and steering angular velocity information of the vehicle, and denotes a steering torque value calculated using the above-described information when an external force is not applied.

At step S130, in order to determine the driving control agent, a difference between the above-described actual steering torque value and the predictive steering torque value is compared with the reference value. By means of this comparison, if the difference between the actual steering torque value and the predictive steering torque value is greater than the preset reference value, it may be determined that the driver has a steering intention at step S130. Otherwise, it may be determined that the driver desires to maintain the autonomous driving or limited autonomous driving state and does not separately have an intention to intervene in driving.

Further, although not shown in the drawing, if it is determined at step S130 that the driver has a steering intention, the step of comparing the number of variations in the torque value of the steering wheel occurring for a preset period of time with the preset reference number of variations may be further performed. As a result of the determination, if the number of variations is less than the preset reference number of variations, it may be determined that the driving control agent is the driver.

Thereafter, at step S140, by the control unit, the driving control authority of the vehicle is transferred depending on the driving control agent determined at step S130. As described above with reference to FIG. 1, if it is determined at step S130 that the driving control agent is the driver, the driving control agent is transferred to the driver at step S140. Thereafter, at step S140, Electric Power Steering (EPS) control for assisting the driver in steering is performed as a steering control method. That is, a driving torque command for EPS control is transferred to the driving unit, and thus the steering control of the vehicle may be performed. In contrast if it is determined at step S130 that the driving control agent is not the driver, the driving unit performs control depending on autonomous driving or limited autonomous driving without performing a separate transferring procedure at step S140.

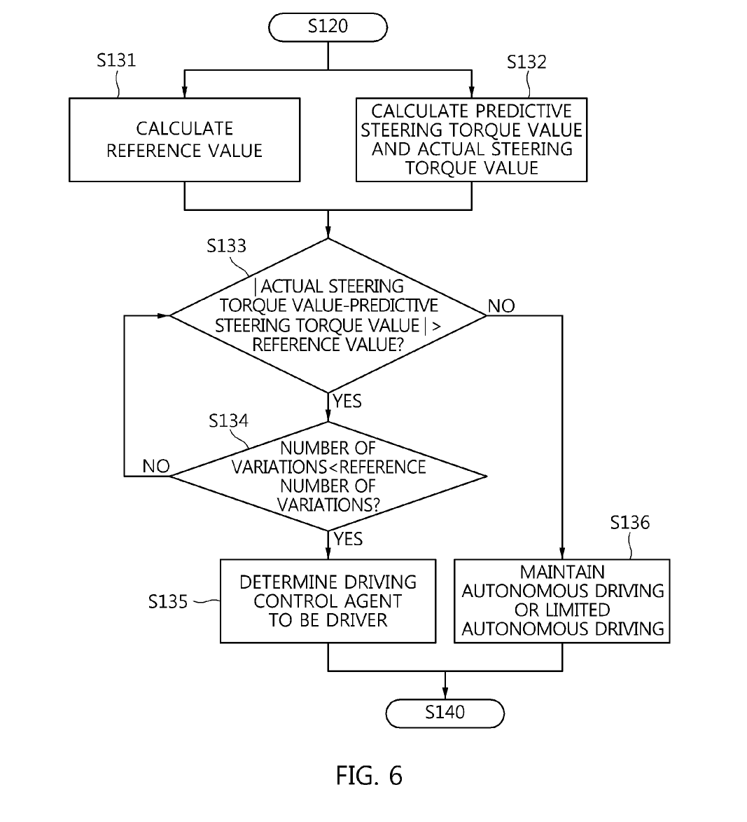

Below, the step of deciding on the driving control agent based on the movement information will be further described with reference to FIG. 6. FIG. 6 is a flowchart showing the step of deciding on the driving control agent based on the movement information, the step being included in the method of operating the steering control apparatus according to an embodiment of the present invention.

First, a reference value is calculated at step S131, and a predictive steering torque value and an actual steering torque value are calculated at step S132. In FIG. 6, steps S131 and S132 are shown as being performed in parallel, but it should be understood that they may be sequentially performed. Further, since the terms such as the reference value, the predictive steering torque value, and the actual steering torque value used at steps S131 and S132 have been described in detail with reference to FIG. 1, a repeated description thereof will be omitted here for the simplification of description of the present specification.

Thereafter, a difference between the actual steering torque value and the predictive steering torque value is compared with the reference value at step S133. At step S133, since the difference between the actual steering torque value and the predictive steering torque value may be obtained as a negative value other than a positive value, the absolute value of the difference is processed, and a comparison between the absolute difference value and the reference value is performed. As a result of the comparison, if the difference is greater than the reference value, it is determined that the driver has a steering intention, and the control proceeds to step S134. Otherwise, the control proceeds to step S136.

Step S134 is performed so as to further improve the precision of results determined at step S133, and is configured such that the driving control agent is further determined based on the number of variations in the torque value of the steering wheel. That is, if it is determined at step S133 that the driver has a steering intention, the procedure of comparing the number of variations in the torque value of the steering wheel occurring for a preset period of time with the preset reference number of variations is further performed at step S134. If it is determined at step S134 that the number of variations is less than the preset reference number of variations, the control proceeds to step S135 where the driving control agent is determined to be the driver. Otherwise, the control returns to step S133 where the above-described procedure is repeated. Thereafter, the results of the determination and control are transferred to step S140.

Step S136 is performed when the difference between the actual steering torque value and the predictive steering torque value is not greater than the reference value at step S133, and is configured to maintain autonomous driving or limited autonomous driving. Therefore, the results of the determination and control are transferred to step S140.

In accordance with the steering control apparatus and the method of operating the apparatus according to the present invention, there is an advantage in that a driver's steering manipulation intention is determined and the driving control authority can be promptly transferred, thus providing more convenience to the driver and coping with an emergency when an emergency occurs.

Further, in accordance with the steering control apparatus and the method of operating the apparatus according to the present invention, there is an advantage in that in a situation in which the malfunction of a steering wheel occurs due to the mistake of a driver or the application of a physical force, even if the steering wheel is unintentionally moved, such movement is sensed, and the driving control authority of the vehicle is not transferred without the driver's intention to manually steer the vehicle, thus securing the driving stability of an intelligent vehicle.

Furthermore, in accordance with the steering control apparatus and the method of operating the apparatus according to the present invention, there is an advantage in that the present invention is not limited to any one of the above-described Smart Parking Assist System (SPAS), Lane Keeping Assist System (LKAS), and Autonomous Driving System (ADS), and may be organically applied to various types of autonomous driving and limited autonomous driving systems.

As described above, optimal embodiments of the present invention have been disclosed in the drawings and the specification. Although specific terms have been used in the present specification, these are merely intended to describe the present invention and are not intended to limit the meanings thereof or the scope of the present invention described in the accompanying claims. Therefore, those skilled in the art will appreciate that various modifications and other equivalent embodiments are possible from the embodiments. Therefore, the technical scope of the present invention should be defined by the technical spirit of the claims.

What is claimed is:

1. A steering control apparatus, comprising:
a sensor unit for sensing movement of an autonomous driving vehicle or a limited autonomous driving vehicle, and calculating movement information;
a determination unit for determining a driver's steering intention using an actual steering torque value of the vehicle, calculated based on the movement information, and a reference value corresponding to speed of the vehicle, and deciding on a driving control agent; and
a control unit for transferring a driving control authority of the vehicle depending on the driving control agent.

2. The steering control apparatus of claim 1, wherein the determination unit comprises:
a steering torque prediction module for calculating a predictive steering torque value using speed, steering angle and steering angular velocity information of the vehicle included in the movement information; and
a steering intention determination module for comparing a difference between the actual steering torque value and the predictive steering torque value with the reference value corresponding to the speed of the vehicle, thus determining the driver's steering intention.

3. The steering control apparatus of claim 2, wherein the steering intention determination module is configured to, if the difference between the actual steering torque value and the predictive steering torque value is greater than the reference value, determine that the driver has a steering intention.

4. The steering control apparatus of claim 1, wherein the determination unit is configured to, if it is determined that the driver has a steering intention, compare a number of variations in a torque value of a steering wheel occurring for a preset period of time with a preset reference number of variations.

5. The steering control apparatus of claim 4, wherein the determination unit is configured to, if the number of variations is less than the preset reference number of variations, determine that the driving control agent is the driver.

6. The steering control apparatus of claim 1, wherein the control unit is configured to, if it is determined by the determination unit that the driver has a steering intention, perform Electric Power Steering (EPS) control via a transferring module.

7. The steering control apparatus of claim 1, wherein the sensor unit comprises at least one of a steering torque sensor, a steering angle sensor, a steering angular velocity sensor, a vehicle speed sensor, a yaw rate sensor, and an acceleration sensor.

8. A method of operating a steering control apparatus, comprising:
sensing, by a sensor unit, movement of an autonomous driving vehicle or a limited autonomous driving vehicle;
calculating, by the sensor unit, movement information based on the movement;
determining, by a determination unit, a driver's steering intention using an actual steering torque value of the vehicle, calculated based on the movement information, and a reference value corresponding to speed of the vehicle, and deciding on, by the determination unit, a driving control agent based on the driver's steering intention; and
transferring, by a control unit, a driving control authority of the vehicle depending on the driving control agent.

9. The method of claim 8, wherein deciding on the driving control agent comprises:
calculating, by a steering torque prediction module, a predictive steering torque value using speed, steering angle and steering angular velocity information of the vehicle included in the movement information; and
comparing, by a steering intention determination module, a difference between the actual steering torque value and the predictive steering torque value with the reference value corresponding to the speed of the vehicle, thus determining the driver's steering intention.

10. The method of claim 9, wherein deciding on the driving control agent comprises determining, by the steering intention determination module, that the driver has a steering intention if the difference between the actual steering torque value and the predictive steering torque value is greater than the reference value.

11. The method of claim 8, wherein deciding on the driving control agent comprises, if it is determined that the driver has a steering intention, comparing a number of variations in a torque value of a steering wheel occurring for a preset period of time with a preset reference number of variations.

12. The method of claim 11, wherein comparing the number of variations with the preset reference number of variations comprises, if the number of variations is less than the preset reference number of variations, determining that the driving control agent is the driver.

13. The method of claim 8, wherein transferring the driving control authority of the vehicle comprises, if it is determined by the determination unit that the driver has a steering intention, performing Electric Power Steering (EPS) control via a transferring module.

14. The method of claim 8, wherein the sensor unit comprises at least one of a steering torque sensor, a steering angle sensor, a steering angular velocity sensor, a vehicle speed sensor, a yaw rate sensor, and an acceleration sensor.
